(19) United States
(12) Patent Application Publication
(10) Pub. No.: US 2009/0175158 A1
(43) Pub. Date: Jul. 9, 2009

(54) CODED VIRTUAL CHANNEL NETWORK

(75) Inventor: Kenneth Shamburger, Greenville, TX (US)

Correspondence Address: HOVEY WILLIAMS LLP, 10801 Mastin Blvd., Suite 1000, Overland Park, KS, 66210, US

(73) Assignee: L3 Communications Integrated Systems, L.P., Greenville, TX (US)

(21) Appl. No.: 11/969,008

(22) Filed: Jan. 3, 2008

(51) Int. Cl. H04J 11/00

(52) U.S. Cl. 370/203

(57) ABSTRACT

A data coding/decoding system for use with a plurality of users includes an encoder, a transmitter, a receiver, and a decoder. The encoder encodes data to be transmitted over a shared physical transmission medium using an orthogonal or convolution code associated with a receiving user. The transmitter transmits the encoded data. Generally, data may be transmitted simultaneously by a plurality of users. The receiver receives a stream of encoded data and forwards it to the decoder, which decodes it based on the orthogonal or convolution code of the receiving user.

### BACKGROUND OF THE INVENTION

1. Field of the Invention

Embodiments of the present invention relate to data communications coding. More particularly, embodiments of the present invention relate to coding and decoding data using a code for simultaneous multi-user communication over a shared physical transmission medium.

2. Description of the Related Art

Computer networks are often formed by physically connecting one computer to another through a physical transmission medium such as a wire-based cable or an optical fiber. Data communication over these networks generally utilizes protocols, such as Ethernet, that treat the physical transmission medium as a single shared communication channel. These protocols allow access to the physical transmission medium to only one user at a time. Thus, if one user wants to send data to another user, the first user must wait until no other user is transmitting on the medium—leading to competition for the medium. This competition results in a large number of collisions and failed attempts to send information. As a result, the rate of successful data communication is diminished.

### SUMMARY OF THE INVENTION

Embodiments of the present invention solve the above-mentioned problems and provide a distinct advance in the art of data communications over a shared physical transmission medium. More particularly, embodiments of the invention provide a data coding/decoding system using an orthogonal or convolution code for multi-user access to a shared physical transmission medium at the same time.

In various embodiments, the system includes an encoder to encode data to be transmitted over a shared physical transmission medium, and a decoder to decode data that is received from a shared physical transmission medium. The system further includes a transmitter for transmitting encoded data over the shared physical transmission medium and a receiver for receiving data from the shared physical transmission medium. The system accommodates a plurality of users and each user is associated with a unique, orthogonal or convolution code.

The encoder encodes data to be transmitted based on the code of the receiving user and forwards the data to the transmitter. The encoder is coupled to a general code storage unit that includes the codes for all users in the system The receiver receives data from the shared physical transmission medium and forwards it to the decoder, which decodes the data. Only the data that has been encoded with the receiving user's code is decoded into non-zero data—all other data is decoded as zeros or null data. The decoder is coupled with an identification code storage unit, which stores the code that is associated with the particular receiving user.

In some embodiments, a network is formed that includes a shared physical transmission medium and a plurality of computing elements. The shared physical transmission medium is capable of propagating data. Each computing element generates data and is coupled to a data coding/decoding system as described above for transmitting and receiving encoded data over the physical transmission medium.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a block diagram of a data coding/decoding system constructed in accordance with various embodiments of the present invention;

FIG. 2 is a block diagram of a network of data coding/decoding systems connected to a shared physical transmission medium; and

FIG. 3 is a flow diagram of steps performed in the operation of the data coding/decoding system.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

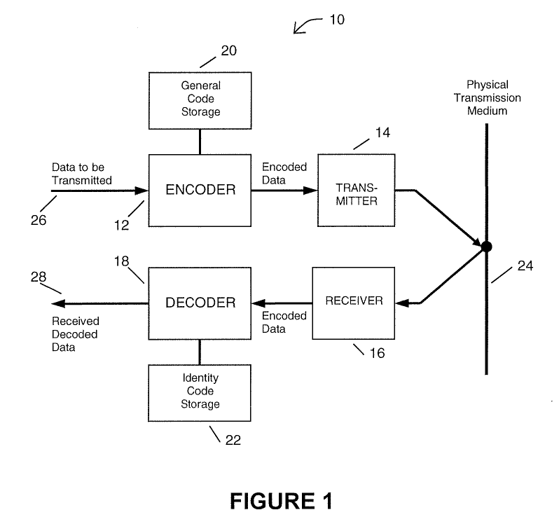

A data coding/decoding system 10, constructed in accordance with various embodiments of the present invention, is shown in FIG. 1. The system includes an encoder 12, a transmitter 14, a receiver 16, a decoder 18, a general code storage unit 20, and an identity code storage unit 22. Also shown is a shared physical transmission medium 24, which may receive data electrically or optically.

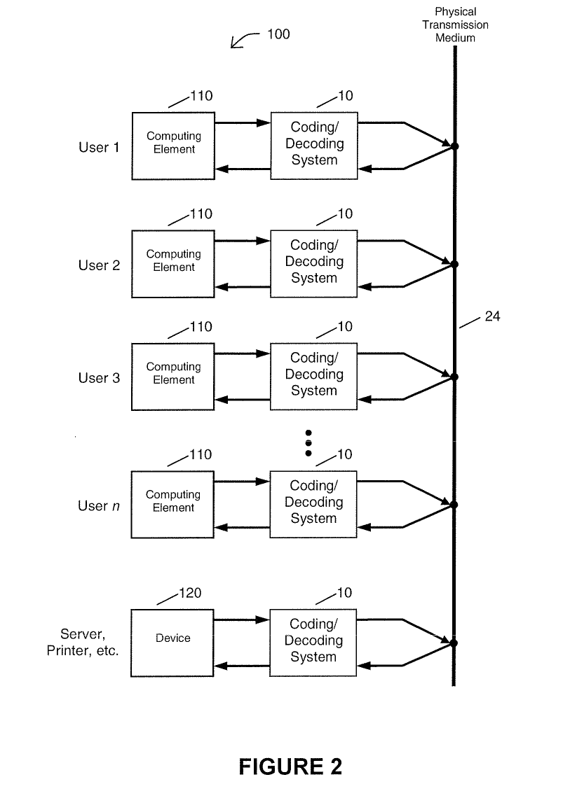

The system 10 may also be utilized in forming a network 100 that can accommodate a plurality of users, as shown in FIG. 2. The network 100 may include a plurality of computing elements 110 or devices 120 that are each coupled with a data coding/decoding system 10. In addition, each system 10 may be coupled with the shared physical transmission medium 24. Data is sent from one user to another by encoding the data with the receiving user's code, wherein each user is associated with a unique orthogonal code. From a conceptual standpoint, a user is equivalent to an electronic component, such as a server or a printer, in that both the user and the component are capable of sending and receiving data. Therefore, discussion that refers to a user generally applies to an electronic component as well.

The encoder 12 encodes data from input line 26 that is to be transmitted to a receiving user. Typically, the input line 26 is connected to a computing element 110, such as a personal computer (PC) or workstation, or a device 120, such as a server or printer. The input line 26 may be a single-bit serial line, or the input 26 may be a multi-bit parallel bus architecture.

In various embodiments, the encoder 12 produces a data output stream that is a meaningful representation of the input data. In some embodiments, the encoder 12 produces a coded word, or plurality of bits, for every bit of the data to be encoded. In other embodiments, the encoder 12 may encode more than one bit at a time. Generally, the encoder 12 encodes data utilizing an orthogonal or convolution code associated with a receiving user as discussed in more detail below. Thus, the encoder 12 may include circuitry to perform mathematical functions, such as multiplication and addition.

The encoder 12 may also include circuitry that can determine the identity of the receiving user from the computing element 110 or device 120 and send a request to the general code storage unit 20 to retrieve the code associated with that user. Thus, communication between the encoder 12 and the general code storage unit may be bidirectional.

The encoder 12 may be formed from digital logic circuitry, analog circuitry, or a combination of both. The encoder 12 may be described as one or more code segments of a hardware description language (HDL) and may be implemented in a field-programmable gate array (FPGA) or other programmable logic device (PLD). The encoder 12 may also include a microprocessor, a microcontroller, or programmable interface controller/computer (PIC), or combinations thereof. Furthermore, the encoder 12 may include either fully-custom or semi-custom application-specific integrated circuitry (ASIC).

In various embodiments, coupled with the encoder 12 is the general code storage unit 20, which stores the codes for all users and supplies the correct code to the encoder 12. Generally, there is one unique orthogonal code associated with each user, that is perhaps assigned by a system or network administrator. There may also be a code associated with all users to handle the situation in which one user wants to broadcast to all other users. In addition, there may be other subgroups of users that are associated with codes or possibly alternative, diagnostic, or emergency codes. The general code storage unit 20 is sized properly to store all codes listed above plus codes for future users or additional categories of codes. Furthermore, in various embodiments, the size of each code, and in turn the amount of storage space required for each code, may depend on the number of users and/or extra codes in the system. Accordingly, each code may increase in length as the number of users increases. As a result, the general code storage unit 20 is optimally a programmable or updatable memory element.

The general code storage unit 20 may include a plurality of registers, such flip-flops or latches, and may be described in one or more code segments of an HDL and may be implemented in an FPGA or other PLD. The general code storage unit 20 may also include random access memory (RAM) elements, that can be either static or dynamic, a programmable read-only memory (PROM), that is erasable either optically or electrically, or combinations thereof. In various embodiments, the general code storage unit 20 may be integrated with the encoder 12.

In various embodiments, the transmitter 14 is coupled to the encoder 12. The transmitter 14 receives encoded data from the encoder 12 to transmit over the shared physical transmission medium 24. The transmitter 14 may receive data in serial form or in parallel form from the encoder 12. But, generally, the transmitter 14 transmits data over the medium 24 in serial format. Thus, the transmitter 14 may include circuitry to convert parallel data into serial data.

Since the shared physical transmission medium 24 may receive data either electrically or optically, the transmitter 14 may include circuitry to drive a wire-based cable, or the transmitter 14 may include circuitry to drive an optical fiber. In various embodiments, the transmitter 14 includes a combination of digital logic circuitry to receive encoded data from the encoder 12 and analog circuitry to drive the shared physical transmission medium 24. Accordingly, portions of the transmitter 14 may be described as one or more code segments of an HDL and may be implemented in an FPGA or other PLD. Other portions of the transmitter 14 may include operational amplifiers (OpAmps) or other line-driving amplifier circuits in addition to optical-fiber driving components, such as, but not limited to, light-emitting diodes (LEDs) or lasers, either surface emitting or edge emitting. Furthermore, all the components of the transmitter 14 may be included in a single hybridly-integrated package. In various embodiments, the transmitter 14 may also be integrated into the encoder 12.

In various embodiments, the shared physical transmission medium 24 is coupled to the output of the transmitter 14 and may propagate data either electrically or optically. The shared physical transmission medium 24 may include wire-based cable, such as twisted-pair cable, either shielded or unshielded, or coaxial cable. The medium 24 may also include optical fiber, such as single-mode fiber or multi-mode fiber. It is also possible that the shared physical transmission medium 24 may include both wire-based cable and optical fiber.

In various embodiments, the receiver 16 is coupled to the shared physical transmission medium 24 to receive encoded data. The receiver 16 then forwards the encoded data in the proper format to the decoder 18. The receiver 16 typically receives data in a serial format and may forward the data to the decoder 18 in serial format or in parallel, and, thus may include circuitry to perform a serial to parallel conversion. In a similar fashion to the transmitter 14, portions of the receiver 16 may be described as one or more code segments of an HDL and may be implemented in an FPGA or other PLD. Other portions of the receiver 16 may include OpAmps or other level-adjusting amplifier circuits in addition to opticalfiber receiving components, such as optical detecting elements or photodetectors. Furthermore, all the components of the receiver 16 may be included in a single hybridly-integrated package. In various embodiments, the receiver 16 may also be integrated into the decoder 18.

In various embodiments, the decoder 18 receives encoded data from the receiver 16. The decoder 18 decodes the data stream on a bit-by-bit basis using the identity code that is retrieved from the identity code storage unit 22. All data that is intended for the particular user is properly decoded and forwarded via an output line 28 to the computing element 110 or device 120. The output line 28 may be a single-bit serial line, or the output 28 may be a multi-bit parallel bus architecture.

The decoder 18 may include circuitry to perform mathematical functions, such as multiplication and addition, and may be formed from digital logic circuitry, analog circuitry, or a combination of both. The decoder 18 may be described as one or more code segments of an HDL and may be implemented in an FPGA or other PLD. The decoder 18 may also include a microprocessor, a microcontroller, or a PIC, or combinations thereof. Furthermore, the decoder 18 may include either fully-custom or semi-custom ASIC.

In various embodiments, coupled with the decoder 18 is the identity code storage unit 22, which stores the orthogonal code that is associated with a particular user. Generally, the identity code storage unit 22 does not require a large capacity. However, adding new users may require a change or expansion of each individual code. Thus, the identity code storage unit 22 is scalable and rewritable. The identity code storage unit 22 may include a plurality of registers, such flip-flops or latches, and may be described in one or more code segments of an HDL and may be implemented in an FPGA or other PLD. The identity code storage unit 22 may also include RAM elements, that can be either static or dynamic, a PROM, that is erasable either optically or electrically, or combinations thereof. In various embodiments, the identity code storage unit 22 may also be integrated with the decoder 18.

As shown in FIG. 2, in various embodiments, the network 100 may be formed with a plurality of users and electronic components. The electronic components, or devices 120, may include file servers, printers, FAX machines, switches, routers, and the like. Each device 120 may be associated with a unique orthogonal code similar to a user. Thus, each computing element 110 and device 120 is coupled to a data coding/decoding system 10 in order to communicate across the shared physical transmission medium 24. By coding data to be transmitted using an orthogonal code, each data coding/decoding system 10 establishes a virtual channel from the sender to the receiver through the network 100 that allows multiple systems 10 to transmit simultaneously because each transmission uses a unique virtual channel.

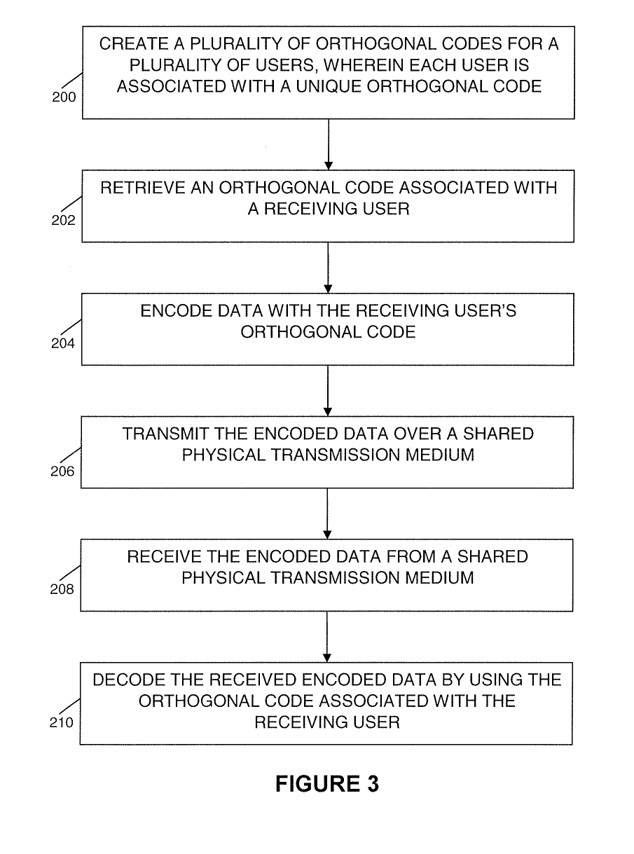

In various embodiments, the operation of the data coding/decoding system 10 is listed in the following steps, as also illustrated in FIG. 3. The steps as shown in FIG. 3 do not imply a particular order of execution. Some steps may be performed before or concurrently with other steps in contrast to what is shown in FIG. 3.

A plurality of orthogonal codes is created for a plurality of users and devices, where a device is considered the equivalent of a user, as listed in step 200. Each user is associated with a unique orthogonal code.

Once a receiving user is determined, the orthogonal code associated with that user is retrieved, as listed in step 202. The data is encoded with the receiving user's orthogonal code, as listed in step 204. The encoded data is transmitted over a shared physical transmission medium, as listed in step 206. The encoded data is received from the shared physical transmission medium, as listed in step 208. The received encoded data is decoded by using the orthogonal code associated with the receiving user, as listed in step 210.

In various embodiments, the orthogonal code may include a Walsh code. The Walsh codes for a simple network 100 of four users includes:

W(0,4)=1, 1, 1, 1

W(1,4)=1, −1, 1, −1

W(2,4)=1, 1, −1, −1

W(3,4)=1, −1, −1, 1

In a simple example, each user is associated with one of the codes—user #1 associated with W(0,4), user #2 associated with W(1,4), etc. Data is encoded such that when a ‘1’ is encoded, a codeword is formed with the code as is, W(n,4). When a ‘0’ is encoded, a codeword is formed with the inverse or negative of the code, −W(n,4). If a user wishes to send data to user #1, the codeword for a ‘1’ is (1, 1, 1, 1) and the codeword for ‘0’ is (−1, −1, −1, −1). A code is orthogonal if it meets the criterion established in Eq. 1.

$$y = {\sum }_{i = 1}^{n} {w}_{i} {c}_{i} = k \qquad Eq . 1$$

where wᵢ is the orthogonal code, cᵢ is the encoded data and k=0 if the cᵢ is not encoded using wᵢ.

In various embodiments, encoded data may involve convolution, as shown in Eq. 2.

$$y = {\sum }_{i = 1}^{n} {w}_{i} {c}_{j - i} \qquad Eq . 2$$

where wᵢ is the orthogonal code and cⱼ₋ᵢ is the encoded data. A convolution code yields original data when convolved with itself. Thus, convolution codes may be utilized in the system 10 as well as orthogonal codes.

Continuing with the example, when user #1 decodes data from the receiver, the mathematical operations of Eq. 2 are applied. A ‘1’ is decoded as (1)(1)+(1)(1)+(1)(1)+(1)(1)=4. A positive result of the decoding operation is interpreted as a ‘1’. A ‘0’ is decoded as (1)(−1)+(1)(−1)+(1)(−1)+(1)(−1)=−4. A negative result of the decoding operation is interpreted as a ‘0’. If user #1 is decoding data intended for user #3 (associated with W(2,4)), a ‘1’ is decoded as (1)(1)+(1)(1)+(1)(−1)+(1)(1)=0. A ‘0’ is decoded as (1)(−1) +(1)(−1)+(1)(1)+(1)(1)=0. Thus, data intended for user #3 is convolved as zero by user #1 (or any other user), which is interpreted as null data.

In various embodiments, orthogonal codes other than Walsh codes may be used and may follow a different procedure from the simple example above for encoding and decoding. A practical implementation of system 10 or network 100 may include protocols for synchronization and framing of the data to be transmitted. The frame of the data may include start bits and stop bits to properly separate each codeword. Other protocols may be applied as well that are directed to the specific shared physical transmission medium 24—whether electrical or optical.

Although the invention has been described with reference to the embodiment illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A data coding/decoding system for use with a plurality of users in a network that includes a shared physical transmission medium, the system comprising:
an encoder for encoding data with an orthogonal code, such that each user is associated with a unique orthogonal code;
a transmitter coupled to the encoder, for transmitting encoded data over the shared physical transmission medium while transmitters of other data coding/decoding systems are transmitting encoded data over the shared transmission medium;
a receiver for receiving encoded data from a physical transmission medium; and
a decoder coupled to the receiver, for decoding data that is encoded with an orthogonal code.

2. The data coding/decoding system of claim 1, further comprising a general code storage unit coupled to the encoder, for storing a plurality of orthogonal codes.

3. The data coding/decoding system of claim 1, further comprising an identity code storage unit coupled to the decoder, for storing at least one orthogonal code that is associated with an individual user.

4. The data coding/decoding system of claim 1, wherein the orthogonal code includes a convolution code.

5. The data coding/decoding system of claim 1, wherein the encoder encodes data with the orthogonal code associated with the user intended to receive the data.

6. A network for use with a plurality of users, the network comprising:
a shared physical transmission medium for propagating data;
a plurality of computing elements for generating data; and
a plurality of data coding/decoding systems, each data coding/decoding system coupled to a computing element and coupled to the shared physical transmission medium, each data coding/decoding system including—
an encoder for encoding data with an orthogonal code, such that each user is associated with a unique orthogonal code,
a transmitter coupled to the encoder, for transmitting encoded data over the shared physical transmission medium while transmitters of other data coding/decoding systems are transmitting encoded data over the shared physical transmission medium,
a receiver for receiving encoded data from the shared physical transmission medium, and
a decoder coupled to the receiver, for decoding data that is encoded with an orthogonal code.

7. The network of claim 6, wherein the computing element further includes a general code storage unit coupled to the encoder, for storing a plurality of orthogonal codes.

8. The network of claim 6, wherein the computing element further includes an identity code storage unit coupled to the decoder, for storing at least one orthogonal code that is associated with an individual user.

9. The network of claim 6, wherein the orthogonal code includes a convolution code.

10. The network of claim 6, wherein the encoder encodes data with the orthogonal code associated with the user intended to receive the data.

11. The network of claim 6, wherein the shared physical transmission medium is a twisted-pair cable.

12. The network of claim 6, wherein the shared physical transmission medium is a coaxial cable.

13. The network of claim 6, wherein the shared physical transmission medium is an optical fiber.

14. A method of data communication over a shared physical transmission medium for use with a plurality of users, the method comprising:
a) encoding data with a receiving user's orthogonal code;
b) transmitting the encoded data over a shared physical transmission medium;
c) receiving encoded data from the shared physical transmission medium; and
d) decoding the received encoded data by using the orthogonal code associated with the receiving user.

15. The method of claim 14, further including the step of creating a plurality of orthogonal codes, wherein each user is associated with a unique orthogonal code.

16. The method of claim 14, further including the step of retrieving an orthogonal code associated with a receiving user.

17. The method of claim 14, wherein the orthogonal code includes a convolution code.
